(19) United States
(12) Patent Application Publication
(10) Pub. No.: US 2026/0291836 A1
(43) Pub. Date: Sep. 24, 2026

(54) DECLARATION-BASED DATA ROUTING FOR ANALYSIS MODULES

(71) Applicant: Dell Products L.P., Round Rock, TX (US)

(72) Inventors: Alan Helmy Abdelhalim, Pflugerville, TX (US); Jacob Vincent Mink, Cedar Park, TX (US)

(21) Appl. No.: 19/087,933

(22) Filed: Mar. 24, 2025

(51) Int. Cl. H04L 43/04

(52) U.S. Cl. CPC H04L 43/04

(57) ABSTRACT

An embodiment receives, at an analytics service of a telemetry manager platform of an information handling system, from an analytics requestor, an analytics request comprising a datatype identifier and a requestor identifier. An embodiment requests, from a data service selected using the datatype identifier, data fulfilling the analytics request. An embodiment computes, using an analytics plug-in and the data received from the data service, an analysis result. An embodiment forwards, to the analytics requestor, the analysis result.

### BACKGROUND

### Field of the Disclosure

The disclosure relates generally to an information handling system, and in particular, to declaration-based data routing for analysis modules.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems incorporate a telemetry manager or telemetry manager platform, a software platform incorporating telemetry, locally computed (i.e., on the information handling system being analyzed) or cloud-based analytics, and data transmission to monitor and report status of the information handling system and its components. Automatically collecting and analyzing telemetry helps an information handling system supplier accurately and efficiently diagnose issues on customer devices and provide the right solutions on the first try and decreases productivity interruption by proactively predicting or detecting device health issues before or as soon as they arise. The telemetry manager supports on-demand, periodic, and event or trigger-based data workflows across collection, analytics, and transmission data operations. The telemetry manager is single-instanced and shared by information handling system management applications and services to optimize performance on user systems. Client application software development kids (SDKs) present a declarative, data-oriented perspective, prioritizing discoverability and ease of use by data scientists and application developers. The platform provides a secure, “Local Data Lake” on the information handling system including raw collected data, locally-computed analytics, and diagnostic test results. Computing analytics locally enables faster, actionable insights reduces the amount of data transmitted to the cloud by default. The platform provides extensibility mechanisms that allow platform extendibility via new or updated analytics plug-ins. The platform provides a management model where individual “datatypes” have associated configuration settings used to dynamically optimize the frequency of their collection, computation, and transmission. The platform defines a core set of telemetry to be collected/computed and transmitted by default, with the rest lying in dormant mode, available to produce and transmit per optional administrator configuration or client requests. The platform merges application requests to single-instance and optimizes operations without further application input.

### SUMMARY

Innovative aspects of the subject matter described in this specification may be embodied in a method comprising: receiving, at an analytics service of a telemetry manager platform of an information handling system, from an analytics requestor, an analytics request comprising a datatype identifier and a requestor identifier; requesting, from a data service selected using the datatype identifier, data fulfilling the analytics request; computing, using an analytics plug-in and the data received from the data service, an analysis result; and forwarding, to the analytics requestor, the analysis result.

Other embodiments of these aspects include corresponding systems, apparatus, and computer programs, configured to perform the actions of the methods, encoded on computer storage devices.

Particular implementations of the subject matter described in this specification can be implemented so as to realize one or more of the following advantages. For example, the implementations meet a need for a software module to receive an analytics request, route the request and needed data to an appropriate plug-in, and report a result to the requestor.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 depicts a block diagram of an example configuration for declaration-based data routing for analysis modules, in accordance with an illustrative embodiment.

FIG. 3 depicts an example of declaration-based data routing for analysis modules, in accordance with an illustrative embodiment.

FIG. 4 depicts example datatypes used in declaration-based data routing for analysis modules, in accordance with an illustrative embodiment.

FIG. 5 depicts a flowchart of an example process for declaration-based data routing for analysis modules. in accordance with an illustrative embodiment.

### DESCRIPTION OF PARTICULAR EMBODIMENT(S)

A telemetry manager in presently available information handling systems supports on-demand, periodic, and event or trigger-based data workflows across collection, analytics, and transmission data operations. Within the telemetry manager, an analytics plug-in is a discrete software module that performs an analytics task, i.e., analyzing data within the system. For example, one analytics plug-in's task might be to monitor a temperature within an information handling system and generate an alert if the temperature exceeds a threshold value.

An analytics plug-in requires one or more specific types of data to analyze. However, because an analytics plug-in is a discrete software module, it lacks detailed knowledge of where to find needed data within modules of the telemetry manager. Further, if a plug-in had the detailed knowledge, this could cause undesirable coupling to current data storage format as well as compromise security by bypassing access controls on the data.

Further, an application requesting data knows what it wants (e.g., the system's average temperature in the last week or an alert if the temperature exceeds a given value) but does not know which analytics plug-ins are installed in a system or which plug-in would be most appropriate to perform a particular task. Nor should an application have the detailed hardware and internal system knowledge required to bypass the telemetry manager and communicate directly with individual system components. Thus, the illustrative embodiments recognize that there is a need for a software module to receive an analytics request, route the request and needed data to an appropriate plug-in, and report a result to the requestor.

In addition, an analytics plug-in may be able to produce an output even with missing or unreliable data. However, the illustrative embodiments recognize that an application requesting analytics needs a means of evaluating the quality or reliability of the result before alerting a user to a system problem that might not be real and incurring expensive support costs.

In a multi-application environment leveraging a single source of truth for data collection, analysis, and alerting, it is essential to track which applications are the ones on whose behalf the telemetry manager platform has performed a telemetry operation. More than one application may request the same piece of data and a direct requestor of a piece of data may be the infrastructure itself acting on behalf an end-user application. Thus, the illustrative embodiments recognize that there is a need to track usage across data each application touches.

In a modular, multi-application environment in which data can be delivered post-install by third-party, partner, or internal software, the illustrative embodiments also recognize that there is a need to ensure that no datatype triggers a circular dependency which could lead to missing data, a system failure, or a poor user experience.

This disclosure discusses methods and systems for declaration-based data routing for analysis modules of an information handling system. In particular, an embodiment receives, from an analytics requestor, an analytics request comprising a datatype identifier; requests, from a data service selected using the datatype identifier, data fulfilling the analytics request; computes, using an analytics plug-in and the data received from the data service, an analysis result; and forwards, to the analytics requestor, the analysis result.

A telemetry manager platform includes one or more data services. A data service of the telemetry manager platform produces data. Some non-limiting examples of a data service of the telemetry manager platform are a data manager service (storing and managing historical, i.e., already collected, data), a telemetry collection service (collecting new data upon request), and an analytics service (producing analytics from historical or new data). As used herein, analytics includes processes that produce analytics results, also referred to herein as analysis results. Analysis results, as used herein include alerts. Alerts are a subset of analysis results that are more urgent or higher priority than and can be based on raw data or the results of one or more analysis results.

An embodiment executes in an analytics service of a telemetry management platform of an information handling system. One or more applications, i.e., analytics requesters, send analytics requests to the telemetry manager, which routes analytics requests to the analytics service. The telemetry manager also routes analytics requests from within the telemetry manager to the analytics service. An analytics request includes a datatype identifier. A datatype identifier identifies (e.g., using a number) a type of data used in the telemetry manager platform. For example, the constant defined as Guid1 might be used to identify fan data and the constant defined as Guid2 might be used to identify thermistor data. Each datatype identifier is registered in a datatype identifier record within the telemetry manager. Registering datatype identifiers in a datatype identifier record enforces consistency among modules of the telemetry manager platform. An analytics request also includes one or more request parameters. Some non-limiting examples of a request parameter are a time range of the data requested and a maximum age of the data requested. In some embodiments, an analytics request includes a requestor identifier identifying an originator of the analytics request.

An analytics service of a telemetry management platform also manages one or more analytics plug-ins. When an analytics plug-in is installed in the telemetry manager platform, the analytics plug-in declares one or more datatype identifiers produced by the plug-in. Declaring multiple datatype identifiers allows datatype identifiers to be grouped logically with shared code. The analytics plug-in also declares one or more dependencies of the datatype identifier produced by the plug-in. A dependency describes data a plug-in uses to produce output. The datatype identifier and any dependencies are registered in the datatype identifier record within the telemetry manager. A dependency includes a dependency datatype identifier (also registered in the datatype identifier record), a dependency type parameter, and a dependency count parameter. A dependency type parameter specifies the kind of data the plug-in uses (e.g., historical within time range, last N samples, last sample for the last N days, current, and the like). The dependency count parameter specifies how much data the plug-in uses (e.g., minimum number of historical samples, number of data samples, number of days with a data sample, and the like). For example, an analytics plug-in for identifying high thermal readings, might have two dependencies. One dependency might be the datatype called ThermalInfo, for which all available historical thermal information readings in addition to the most current fresh reading within a requested time range are requested. Another dependency might be the datatype called CpuStaticInfo, for which one historical reading is requested. As another example, an analytics plug-in for CPU analysis might have two dependencies, CPU Static Info (requesting collection of one sample including cache data) and CPU Dynamic Data (requesting the last 25 samples in the range between a minimum and maximum timestamp). A datatype identifier and any dependencies of a plug-in are referred to as metadata of the plug-in.

During an analytics plug-in installation process, one embodiment adds the plug-in's declared datatype identifier and any dependencies of the datatype identifier to a dependency cycle graph maintained by the embodiment and including the plurality of datatype identifiers registered in a datatype identifier record. If the embodiment, using a presently available technique, detects a cycle in the dependency cycle graph, the embodiment rejects activation of the analytics plug-in and removes the plug-in's declared datatype identifier and any dependencies of the datatype identifier from the dependency cycle graph.

A data service of the telemetry manager platform also declares a datatype identifier produced by the data service, as well as any dependencies the data service uses to produce output. The datatype identifier and any dependencies are registered in the datatype identifier record within the telemetry manager. For example, MemoryAnalysis telemetry data might have datatype ID 5.

An embodiment uses the datatype identifier in an analytics request to select an analytics plug-in to perform the requested analytics. One embodiment selects an analytics plug-in with a datatype identifier produced by the plug-in that matches the datatype identifier in the analytics request.

An embodiment uses one or more dependencies of the selected analytics plug-in, as well as any parameters in the analytics request or a dependency, to select a data service that produces a datatype identified in a dependency. For example, if a dependency is the datatype called CpuStaticInfo, for which historical data is requested, an embodiment might select the data manager service, which stores and manages historical data. As another example, if a dependency is the datatype called ThermalInfo, for which historical and current data is requested, an embodiment might select both the data manager service and the telemetry collection service (which collects new data upon request). An embodiment requests data fulfilling the analytics request from a selected data service.

One embodiment generates a nonce corresponding to an analytics request and includes the nonce in the data request to the selected data service. A nonce is a portion of data unique to the analytics request. One embodiment generates the nonce using a monotonically increasing sequence. In another embodiment, the nonce is a pseudo-random number generated using a pseudo-random number generator, a presently available technique. If the selected data service receives a data request that includes a nonce the data service has already seen, there is a dependency cycle and the data service generates a datatype cycle error. One embodiment sends, subsequent to receiving the datatype cycle error, an error code to the analytics requestor. Another embodiment deletes, subsequent to receiving a datatype cycle error, the selected analytics plug-in's datatype identifier from a datatype identifier record.

One embodiment computes a data quality score corresponding to the data received from the data service. A data quality score is a measure of the quality of the data input to the selected analytics plug-in. One embodiment uses the dependency type parameter and dependency count parameter of the selected analytics plug-in to compute the data quality score. In particular, if there is one dependency type parameter and it calls for current data or non-periodic historic data, an embodiment compares the number of received data samples to the number of expected samples in dependency count parameter. If the dependency type parameter calls for historical periodic data, given the interval I at which the data was collected, the number N of samples collected, and the time range R requested, an embodiment computes I*N/R. If the dependency type parameter calls for the last N samples or the last sample of the last N days, an embodiment computes the ratio of actual samples to N. If the dependency type parameter calls for an analysis, given the number of days in the requested range, an embodiment computes the ratio of days for which a valid analysis was returned to the number of days in the range. For example, an analytics plug-in assessing patterns of high CPU usage might expect the last 25 samples of CPU dynamic data. If the data service only provides 23 samples, the data quality score is 23/25. As another example, an analytics plug-in assessing daily patterns of disk usage might expect the disk usage data at the end of each day for the last 7 days. If the data service only provides 2 samples, the data quality score is 2/7. If there are multiple dependency type parameters, an embodiment computes a data quality score relative to each dependency type parameter and averages the individual scores to obtain a final data quality score. Other rules for data quality score computation are also possible and contemplated within the scope of the illustrative embodiments.

An embodiment sends data received from the data service to the selected analytics plug-in which computes an analysis result from the data. An embodiment forwards the analysis result to the analytics requestor.

One embodiment also sends a data quality score computed on data received from the data service to the selected analytics plug-in. The selected analytics plug-in has the option to return an error code instead of or in addition to computing an analysis result (e.g., if the data quality score indicates that there is insufficient data for a meaningful analysis result. The selected analytics plug-in also has the option to compute an analytics score on data received from the data service. The analytics score is based on the plug-in's domain-specific knowledge as another measure of the confidence in the plug-in's results. In one non-limiting example of use of a plug-in's specific domain knowledge for an analysis score, if a plug-in knows that fan speed data is only reliable in the range of 0-2500 revolutions per minute (RPM) and the plug-in receives data that is outside of that range, the plug-in might provide a lower analysis score than normal, indicating that an error has been introduced into the analysis by this “out of spec” data. An embodiment forwards the data quality score and analysis result (and optionally the analytics score) to the analytics requestor.

An embodiment also forwards the analysis result, as well as identifiers of the data used to generate the result, to the data manager service for storage and possible re-use. One embodiment forwards both the analysis result and the requestor identifier of the requestor of the analysis to the data manager service for storage and possible re-use. Then, if an embodiment receives a second analytics request including the same datatype identifier from a new requestor, the embodiment requests the previous analysis result from the data manager service and forwards the analysis result and the new requestor's identifier to the new requestor, without having to repeat the analysis. Also, if an embodiment receives a third analytics request from the original requestor (e.g., requesting all results previously sent to the requestor or a filtering of results previously sent to the requestor), the embodiment requests data tagged with the requester identifier from the data manager service and forwards the results and the requestor's identifier to the requestor.

Within the telemetry manager platform, data is referenced by a data identifier. A data identifier includes a datatype identifier representing the type of data, an item identifier identifying the module the data came from, and a group identifier identifying a group of data records that were created together. For example, if MemoryAnalysis, telemetry data with datatype ID 5, is run on all four dual in-line memory modules (DIMMs) in a system, then the data produced would have data identifiers of {DatatypeId: 5, ItemId: DIMM_0, GroupId: 1}, {DatatypeId: 5, ItemId: DIMM_1, GroupId: 1}, {DatatypeId: 5, ItemId: DIMM_2, GroupId: 1}, and {DatatypeId: 5, ItemId: DIMM_3, GroupId: 1}.triple (DatatypeId, GroupId, ItemId).

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

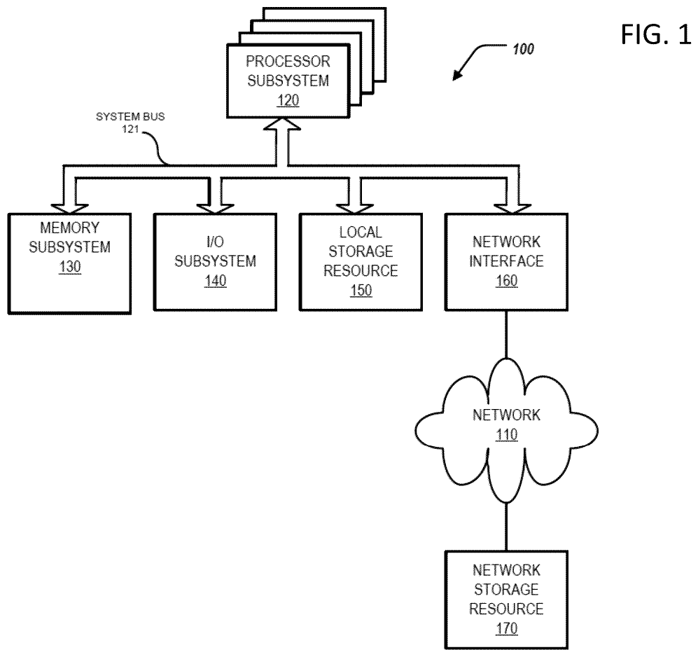

Particular embodiments are best understood by reference to FIGS. 1-5 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a software application implementing declaration-based data routing for analysis module. The software application can be included by the memory subsystem 130. The software application can include a computer-executable program (software). The software application can be executed by the processor subsystem 120.

The information handling system 100 can also include a second software application implementing embedded controller functionality. The second software application can be in communication with the processor subsystem 120 or included in the processor subsystem 120. In some examples, the second software application is included by an embedded controller (EC) of the information handling system 100. In some examples, the second software application is included by baseband management controller of the information handling system 100.

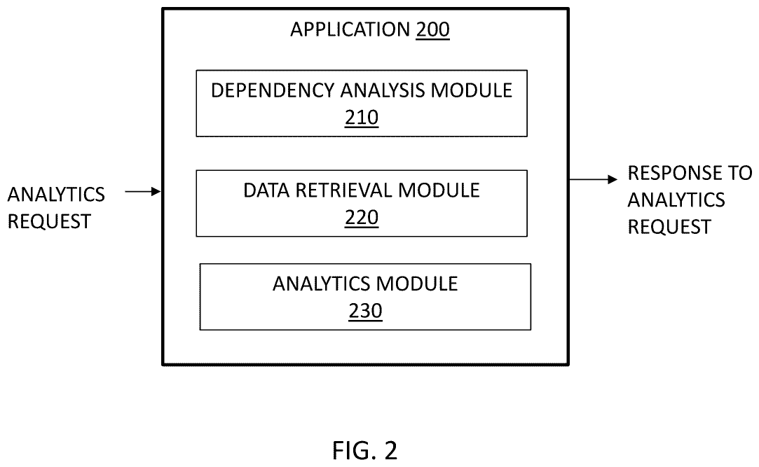

FIG. 2 depicts a block diagram of an example configuration for declaration-based data routing for analysis modules, in accordance with an illustrative embodiment. Application 200 executes in information handling system 100 of FIG. 1.

Application 200 executes in an analytics service of a telemetry management platform of an information handling system. One or more applications, i.e., analytics requesters, send analytics requests to the telemetry manager, which routes analytics requests to the analytics service. The telemetry manager also routes analytics requests from within the telemetry manager to the analytics service. An analytics request includes a datatype identifier. A datatype identifier identifies (e.g., using a number) a type of data used in the telemetry manager platform. For example, the constant defined as Guid1 might be used to identify fan data and the constant defined as Guid2 might be used to identify thermistor data. Each datatype identifier is registered in a datatype identifier record within the telemetry manager. Registering datatype identifiers in a datatype identifier record enforces consistency among modules of the telemetry manager platform. An analytics request also includes one or more request parameters. Some non-limiting examples of a request parameter are a time range of the data requested and a maximum age of the data requested. In some implementations of application 200, an analytics request includes a requestor identifier identifying an originator of the analytics request.

An analytics service of a telemetry management platform also manages one or more analytics plug-ins. When an analytics plug-in is installed in the telemetry manager platform, the analytics plug-in declares one or more datatype identifiers produced by the plug-in. Declaring multiple datatype identifiers allows datatype identifiers to be grouped logically with shared code. The analytics plug-in also declares one or more dependencies of the datatype identifier produced by the plug-in. A dependency describes data a plug-in uses to produce output. The datatype identifier and any dependencies are registered in the datatype identifier record within the telemetry manager. A dependency includes a dependency datatype identifier (also registered in the datatype identifier record), a dependency type parameter, and a dependency count parameter. A dependency type parameter specifies the kind of data the plug-in uses (e.g., historical within time range, last N samples, last sample for the last N days, current, and the like). The dependency count parameter specifies how much data the plug-in uses (e.g., minimum number of historical samples, number of data samples, number of days with a data sample, and the like). For example, an analytics plug-in for identifying high thermal readings, might have two dependencies. One dependency might be the datatype called ThermalInfo, for which all available historical thermal information readings in addition to the most current fresh reading within a requested time range are requested. Another dependency might be the datatype called CpuStaticInfo, for which one historical reading is requested. As another example, an analytics plug-in for CPU analysis might have two dependencies, CPU Static Info (requesting collection of one sample including cache data) and CPU Dynamic Data (requesting the last 25 samples in the range between a minimum and maximum timestamp). A datatype identifier and any dependencies of a plug-in are referred to as metadata of the plug-in.

During an analytics plug-in installation process, one implementation of application 200 adds the plug-in's declared datatype identifier and any dependencies of the datatype identifier to a dependency cycle graph maintained by application 200 and including the plurality of datatype identifiers registered in a datatype identifier record. If application 200, using a presently available technique, detects a cycle in the dependency cycle graph, application 200 rejects activation of the analytics plug-in and removes the plug-in's declared datatype identifier and any dependencies of the datatype identifier from the dependency cycle graph.

A data service of the telemetry manager platform also declares a datatype identifier produced by the data service, as well as any dependencies the data service uses to produce output. The datatype identifier and any dependencies are registered in the datatype identifier record within the telemetry manager. For example, MemoryAnalysis telemetry data might have datatype ID 5.

Dependency analysis module 210 uses the datatype identifier in an analytics request to select an analytics plug-in to perform the requested analytics. One implementation of module 210 selects an analytics plug-in with a datatype identifier produced by the plug-in that matches the datatype identifier in the analytics request.

Module 210 uses one or more dependencies of the selected analytics plug-in, as well as any parameters in the analytics request or a dependency, to select a data service that produces a datatype identified in a dependency. For example, if a dependency is the datatype called CpuStaticInfo, for which historical data is requested, module 210 might select the data manager service, which stores and manages historical data. As another example, if a dependency is the datatype called ThermalInfo, for which historical and current data is requested, module 210 might select both the data manager service and the telemetry collection service (which collects new data upon request). Data retrieval module 220 requests data fulfilling the analytics request from a selected data service.

One implementation of module 220 generates a nonce corresponding to an analytics request and includes the nonce in the data request to the selected data service. A nonce is a portion of data unique to the analytics request. One implementation of module 220 generates the nonce using a monotonically increasing sequence. In another implementation of module 220, the nonce is a pseudo-random number generated using a pseudo-random number generator, a presently available technique. If the selected data service receives a data request that includes a nonce the data service has already seen, there is a dependency cycle and the data service generates a datatype cycle error. One implementation of application 200 sends, subsequent to receiving the datatype cycle error, an error code to the analytics requestor. Another implementation of application 200 deletes, subsequent to receiving a datatype cycle error, the selected analytics plug-in's datatype identifier from a datatype identifier record.

One implementation of module 220 computes a data quality score corresponding to the data received from the data service. A data quality score is a measure of the quality of the data input to the selected analytics plug-in. One implementation of module 220 uses the dependency type parameter and dependency count parameter of the selected analytics plug-in to compute the data quality score. In particular, if there is one dependency type parameter and it calls for current data or non-periodic historic data, module 220 compares the number of received data samples to the number of expected samples in dependency count parameter. If the dependency type parameter calls for historical periodic data, given the interval I at which the data was collected, the number N of samples collected, and the time range R requested, module 220 computes I*N/R. If the dependency type parameter calls for the last N samples or the last sample of the last N days, module 220 computes the ratio of actual samples to N. If the dependency type parameter calls for an analysis, given the number of days in the requested range, module 220 computes the ratio of days for which a valid analysis was returned to the number of days in the range. For example, an analytics plug-in assessing patterns of high CPU usage might expect the last 25 samples of CPU dynamic data. If the data service only provides 23 samples, the data quality score is 23/25. As another example, an analytics plug-in assessing daily patterns of disk usage might expect the disk usage data at the end of each day for the last 7 days. If the data service only provides 2 samples, the data quality score is 2/7. If there are multiple dependency type parameters, module 220 computes a data quality score relative to each dependency type parameter and averages the individual scores to obtain a final data quality score. Other rules for data quality score computation are also possible.

Analytics module 230 sends data received from the data service to the selected analytics plug-in which computes an analysis result from the data. Application 200 forwards the analysis result to the analytics requestor.

One implementation of module 230 also sends a data quality score computed on data received from the data service to the selected analytics plug-in. The selected analytics plug-in has the option to return an error code instead of or in addition to computing an analysis result (e.g., if the data quality score indicates that there is insufficient data for a meaningful analysis result. The selected analytics plug-in also has the option to compute an analytics score on data received from the data service. The analytics score is based on the plug-in's domain-specific knowledge as another measure of the confidence in the plug-in's results. In one non-limiting example of use of a plug-in's specific domain knowledge for an analysis score, if a plug-in knows that fan speed data is only reliable in the range of 0-2500 revolutions per minute (RPM) and the plug-in receives data that is outside of that range, the plug-in might provide a lower analysis score than normal, indicating that an error has been introduced into the analysis by this “out of spec” data. Application 200 forwards the data quality score and analysis result (and optionally the analytics score) to the analytics requestor.

Application 200 also forwards the analysis result, as well as identifiers of the data used to generate the result, to the data manager service for storage and possible re-use. One implementation of application 200 forwards both the analysis result and the requestor identifier of the requestor of the analysis to the data manager service for storage and possible re-use. Then, if application 200 receives a second analytics request including the same datatype identifier from a new requestor, application 200 requests the previous analysis result from the data manager service and forwards the analysis result and the new requestor's identifier to the new requestor, without having to repeat the analysis. Also, if application 200 receives a third analytics request from the original requestor (e.g., requesting all results previously sent to the requestor or a filtering of results previously sent to the requestor), application 200 requests data tagged with the requester identifier from the data manager service and forwards the results and the requestor's identifier to the requestor.

Within the telemetry manager platform, data is referenced by a data identifier. A data identifier includes a datatype identifier representing the type of data, an item identifier identifying the module the data came from, and a group identifier identifying a group of data records that were created together. For example, if MemoryAnalysis, telemetry data with datatype ID 5, is run on all four dual in-line memory modules (DIMMs) in a system, then the data produced would have data identifiers of {DatatypeId: 5, ItemId: DIMM_0, GroupId: 1}, {DatatypeId: 5, ItemId: DIMM_1, GroupId: 1}, {DatatypeId: 5, ItemId: DIMM_2, GroupId: 1}, and {DatatypeId: 5, ItemId: DIMM_3, GroupId: 1}.triple (DatatypeId, GroupId, ItemId).

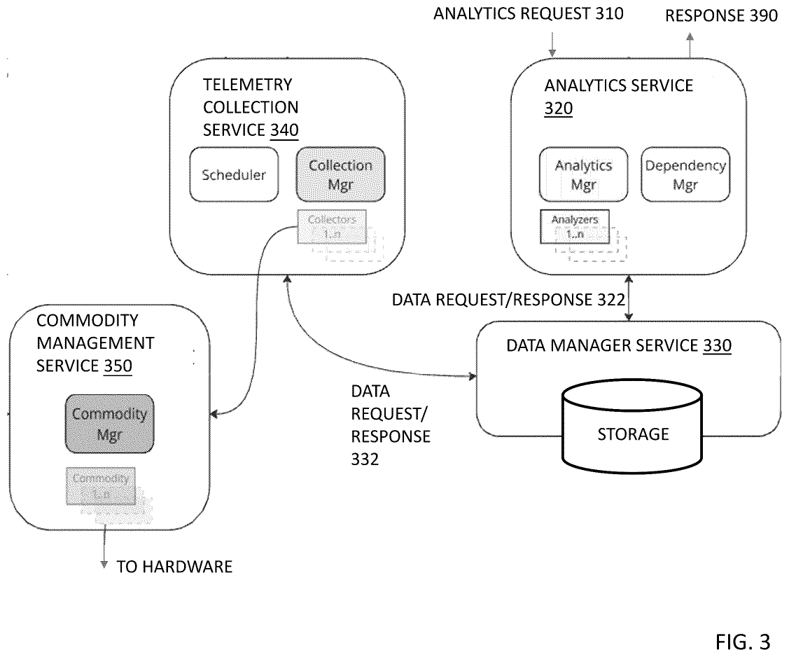

FIG. 3 depicts an example of declaration-based data routing for analysis modules, in accordance with an illustrative embodiment.

A telemetry manager platform includes one or more data services. A data service of the telemetry manager platform produces data. For example, data manager service 330 stores and manages historical, i.e., already collected, data. Telemetry collection service 340 collects new data upon request via commodity management service 350, which accesses information system handling components such as a fan, battery, or temperature sensor. Data manager service 330 and telemetry collection service 340 communicate via data request/response 332, and data manager service 330 stores collected data for later use. Analytics service 320 receives analytics request 310 and, via data request/response 322, produces analytics or analysis results from historical or new data.

Application 200 in FIG. 2 executes in analytics service 320 of a telemetry management. One or more applications, i.e., analytics requesters, send analytics requests (e.g., analytics request 310) to the telemetry manager, which routes analytics requests to analytics service 320. The telemetry manager also routes analytics requests from within the telemetry manager to analytics service 320. Analytics service 320 includes one or more analyzers, also referred to as analytics plug-ins. Analytics service 320 responds to analytics request 310 with response 390.

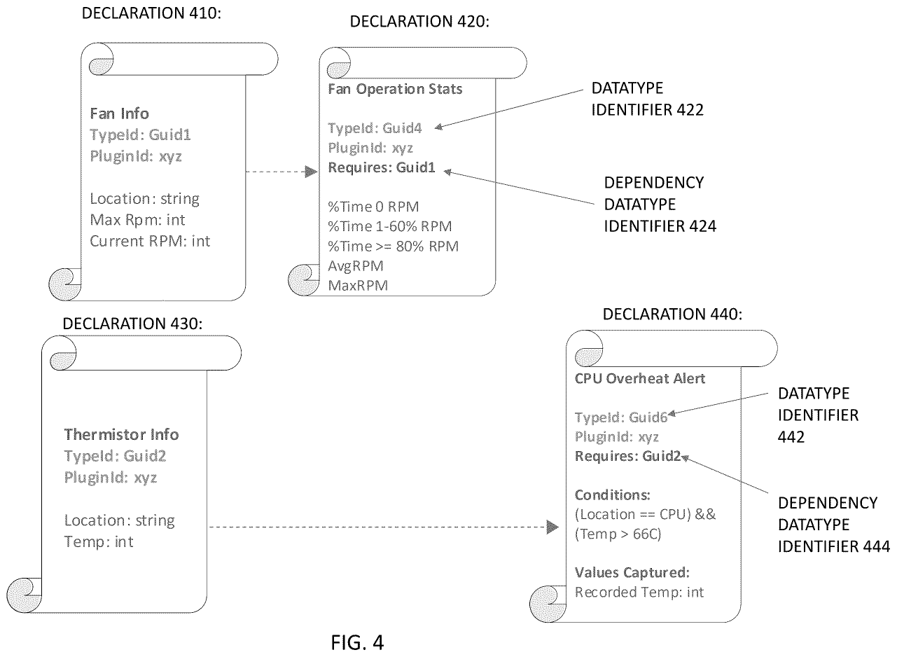

FIG. 4 depicts example datatypes used in declaration-based data routing for analysis modules, in accordance with an illustrative embodiment.

Declaration 410 depicts the fan information datatype, with a datatype identifier of Guid1. Declaration 430 depicts the fan operation statistics datatype, an analytics plug-in's declaration, with datatype identifier 422 of Guid4 and dependency datatype identifier 424 of Guid1, indicating that the fan operation statistics plug-in requires fan information data. Declaration 420 depicts the thermistor information datatype, with a datatype identifier of Guid2. Declaration 440 depicts the CPU overheat alert datatype, an analytics plug-in's declaration, with datatype identifier 442 of Guid6 and dependency datatype identifier 444 of Guid2, indicating that the fan operation statistics plug-in requires thermistor information data.

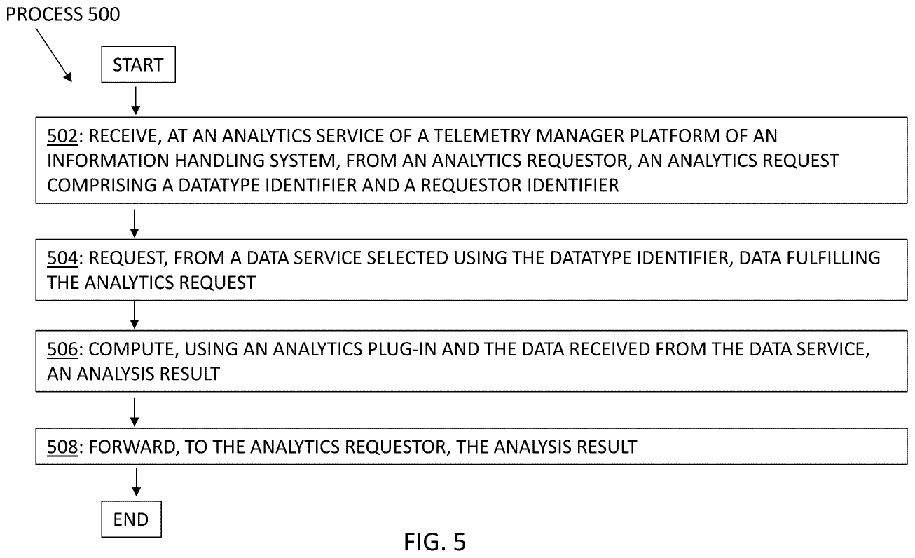

FIG. 5 depicts a flowchart of an example process for declaration-based data routing for analysis modules in accordance with an illustrative embodiment. Process 500 can be executed using application 200 in FIG. 2.

In block 502, the process receives, at an analytics service of a telemetry manager platform of an information handling system, from an analytics requestor, an analytics request comprising a datatype identifier and a requestor identifier. In block 504, the process requests, from a data service selected using the datatype identifier, data fulfilling the analytics request. In block 506, the process computes, using an analytics plug-in and the data received from the data service, an analysis result. In block 508, the process forwards, to the analytics requestor, the analysis result.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method comprising:
receiving, at an analytics service of a telemetry manager platform of an information handling system, from an analytics requestor, an analytics request comprising a datatype identifier and a requestor identifier;
requesting, from a data service selected using the datatype identifier, data fulfilling the analytics request;
computing, using an analytics plug-in and the data received from the data service, an analysis result; and
forwarding, to the analytics requestor, the analysis result.

2. The computer-implemented method of claim 1, wherein the analytics request comprises a request to compute an analysis result on telemetry data of the information handling system.

3. The computer-implemented method of claim 1, wherein the data service comprises a telemetry collection collecting telemetry data of the information handling system.

4. The computer-implemented method of claim 1, wherein the data service comprises a data manager service managing stored telemetry data of the information handling system.

5. The computer-implemented method of claim 4, further comprising:
forwarding, to the data manager service, the analysis result and the requestor identifier.

6. The computer-implemented method of claim 5, further comprising:
receiving, from a second analytics requestor, a second analytics request comprising the datatype identifier and a second requestor identifier;
requesting, from the data manager service. the analysis result; and
forwarding, to the second analytics requestor, the second requestor identifier and the analysis result received from the data manager service.

7. The computer-implemented method of claim 5, further comprising:
receiving, from the analytics requestor, a third analytics request comprising the requestor identifier;
requesting, from the data manager service. data tagged with the requester identifier; and
forwarding, to the analytics requestor, data received from the data manager service in response to the requesting.

8. An information handling system comprising a processor having access to memory media storing instructions executable by the processor to perform operations, comprising:
receiving, at an analytics service of a telemetry manager platform of an information handling system, from an analytics requestor, an analytics request comprising a datatype identifier and a requestor identifier;
requesting, from a data service selected using the datatype identifier, data fulfilling the analytics request;
computing, using an analytics plug-in and the data received from the data service, an analysis result; and
forwarding, to the analytics requestor, the analysis result.

9. The information handling system of claim 8, wherein the analytics request comprises a request to compute an analysis result on telemetry data of the information handling system.

10. The information handling system of claim 8, wherein the data service comprises a telemetry collection collecting telemetry data of the information handling system.

11. The information handling system of claim 8, wherein the data service comprises a data manager service managing stored telemetry data of the information handling system.

12. The information handling system of claim 11, further comprising:
forwarding, to the data manager service, the analysis result and the requestor identifier.

13. The information handling system of claim 12, further comprising:
receiving, from a second analytics requestor, a second analytics request comprising the datatype identifier and a second requestor identifier;
requesting, from the data manager service. the analysis result; and
forwarding, to the second analytics requestor, the second requestor identifier and the analysis result received from the data manager service.

14. The information handling system of claim 12, further comprising:
receiving, from the analytics requestor, a third analytics request comprising the requestor identifier;
requesting, from the data manager service. data tagged with the requester identifier; and
forwarding, to the analytics requestor, data received from the data manager service in response to the requesting.

15. A non-transitory computer-readable medium storing software comprising instructions executable by one or more computers which, upon such execution, cause the one or more computers to perform operations comprising:
receiving, at an analytics service of a telemetry manager platform of an information handling system, from an analytics requestor, an analytics request comprising a datatype identifier and a requestor identifier;
requesting, from a data service selected using the datatype identifier, data fulfilling the analytics request;
computing, using an analytics plug-in and the data received from the data service, an analysis result; and
forwarding, to the analytics requestor, the analysis result.

16. The non-transitory computer-readable medium of claim 15, wherein the analytics request comprises a request to compute an analysis result on telemetry data of the information handling system.

17. The non-transitory computer-readable medium of claim 15, wherein the data service comprises a telemetry collection collecting telemetry data of the information handling system.

18. The non-transitory computer-readable medium of claim 15, wherein the data service comprises a data manager service managing stored telemetry data of the information handling system.

19. The non-transitory computer-readable medium of claim 18, further comprising:
forwarding, to the data manager service, the analysis result and the requestor identifier.

20. The non-transitory computer-readable medium of claim 19, further comprising:
receiving, from a second analytics requestor, a second analytics request comprising the datatype identifier and a second requestor identifier;
requesting, from the data manager service. the analysis result; and
forwarding, to the second analytics requestor, the second requestor identifier and the analysis result received from the data manager service.
